(19) United States
(12) Patent Application Publication
(10) Pub. No.: US 2018/0314925 A1
(43) Pub. Date: Nov. 1, 2018

(54) SYSTEMS AND METHODS FOR SENDING NOTIFICATIONS BASED ON PREDICTED EFFECTIVENESS

(71) Applicant: Facebook, Inc., Menlo Park, CA (US)

(72) Inventors: Jason Gauci, Mountain View, CA (US); Xiaohui Ye, Fremont, CA (US); Yuandong Tian, Menlo Park, CA (US)

(21) Appl. No.: 15/499,835

(22) Filed: Apr. 27, 2017

(51) Int. Cl. G06N 3/04; G06N 3/08

(52) U.S. Cl. CPC G06N 3/0445; H04L 51/32; G06N 3/08

(57) ABSTRACT

In one embodiment, a method for sending notifications includes accessing a data set, with each data being associated with a first user and including (1) a first action, first state, and first reward that are associated with a first time period, and (2) a second action and second state that are associated with a second time period. The data set may be used to train a recurrent machine-learning model configured to take as inputs a state and action associated with a user and a time period, and predict a cumulative reward over multiple time periods. The cumulative reward may be recurrently defined based on an application of the recurrent machine-learning model to the user's subsequent state and action. The trained model may be used to predict whether sending a notification to a target user is justified based on a predicted cumulative reward.

### TECHNICAL FIELD

This disclosure generally relates to using machine-learning to predict the effectiveness of notifications.

### BACKGROUND

Systems and networks may often desire certain actions to be performed by users, such as managing their pages, engaging in social-networking activities, providing a review/recommendation, viewing or accepting offers/advertisements, and any other types of online activities. One approach that systems may use to prod users to act is by sending notifications or messages to those users. For example, a notification may inform a user that, “Your chess club page has 3 new messages,” or remind the user, “Don't forget to manage your chess club page today!” Upon receiving a notification, some users may promptly perform actions related to the notification, some users may wait several days before acting, some may act after seeing several subsequent notifications, and some may ignore the notifications entirely.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

In addition to personal profiles, the social-networking system may also enable users to create and manage pages (e.g., a content source) associated with, e.g., an entity (e.g., company, organization, or institution), local business or place, brand, a cause, a community, a group (e.g., sports team/group, band, club, etc.), entertainment, and any other entity or concept. Each page may have one or more administrators (e.g., 1, 1.7, or 2 administrators per page on average). A social-networking system may have millions of pages (e.g., 150 million) and administrators (e.g., 300 million).

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

The embodiments disclosed herein relates to systems, medias, and methods for predictively identifying target recipients of notifications whose behavior would most likely be influenced by notifications. In other words, the embodiments herein relates to identifying recipients on which notifications would most likely be effective. In particular embodiments, machine learning may be used to predict a likely cumulative reward (e.g., a measure of users engaging in the desired activities) over the course of multiple time periods for sending a notification to a particular user. The reward prediction may be used to determine whether a notification should be sent to the user.

The embodiments disclosed here are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example method for sending notifications based on predicted effectiveness of the notifications.

FIG. 2 illustrates an example network environment associated with a social-networking system.

FIG. 3 illustrates an example social graph.

FIG. 4 illustrates an example computer system.

### DESCRIPTION OF EXAMPLE EMBODIMENTS

Systems and networks may often desire certain actions to be performed by users, as discussed above. For example, an objective of a social-networking system may be to keep administrators engaged on a daily basis so that their pages are kept up-to-date. The social-networking system may perform various actions to remind administrators to manage their pages. For example, the social networking system may send out notifications. However, the number of notifications that the system is configured to send per day may be limited (e.g., 10 million, 20 million, or 50 million per day) and substantially less than the population of administrators (e.g., 100 million, 200 million, or 300 million). The notification limit may be imposed for a variety of reasons, such as concerns over diminishing effectiveness of notifications due to over exposure. To make the most effective use of the limited number of notifications, it is desirable to develop a model to measure the effectiveness of sending a notifications and deliver notifications to those administrators where notification effectiveness is relatively high. Thus, it would be desirable to make the most of the limited resources (in this case, notifications) and target them for administrators who are most likely to manage their pages in response to the notifications (maximum effectiveness), rather than wasting notifications on administrators who would have engaged regardless of the notifications and those who would not engage despite the notifications. Furthermore, although this disclosure uses the above use case as an example of where the subject of the present disclosures may be applicable, this disclosure contemplates any suitable application of the disclosed subject matter. For example, the disclosed subject matter may also be applicable to, without limitation, sending targeted notifications or messages to social-networking users to increase the likelihood of them engaging with their personal profiles/friends.

In particular embodiments, a machine learning model may be trained to output a likelihood of an administrator managing his/her page when a notification is sent. This may be described as the probability of a user being engaged given features associated with the user and the page that he/she manages (e.g., P(engage|page, user)). In particular embodiments, a machine-learning model (e.g., linear combination of weighted features, neural networks, etc.) may be used to predict the likelihood. With supervised machine learning, the training data may include a set of tuples, each representing various characteristics of an administrator and his/her page. For example, if a social-networking system includes a chess club page with Bobby and Magnus as its administrators, one tuple may represent the page-admin pair of the chess club page and Bobby, and another tuple may represent the page-admin pair of the chess club page and Magnus. Positive labels may be given to page-admin pairs when administrators are active after notifications are sent, while negative labels may be given to page-admin pairs in two cases: 1) administrators remaining inactive after notifications are sent, or 2) administrators becoming active even without notifications. This policy, however, may not be suitable in certain scenarios, since there may be administrators who may begin trending active if shown notifications, but this trend requires the model to have a multi-day horizon. Further, if a page administrator will be active with a very high probability with or without a notification, sending a notification will not improve a metric aimed at maximizing the effective use of notifications.

In particular embodiments, reinforcement learning (RL) may be used to account for multi-day (or any other units of time periods) behavior. In particular embodiments, the present problem may be modeled as follows. Each page-admin pair may be associated with a state (denoted as s), which in particular embodiments may represent data needed for deciding a single action. For example, the state of a page-admin pair may comprise features of the administrator and features of the page. For example, features may include characteristics of the administrator (e.g., location, gender, age, typical device used for managing his/her page, engagement rate with the social-networking system in general, etc.), characteristics of the page (e.g., the type of entity or concept represented by the page, viewers/followers, viewer activity rate, etc.), and/or characteristics of the environment (e.g., time of day, day of week, holidays, seasons, etc.). Features may also include metrics related to the activity that the notification is intended to solicit, and may change from day to day (or time period to time period). For instance, certain features associated with a page-admin pair be include the recent history of notifications and engagement (e.g., the number of days since the administrator last engaged/updated his/her page, the number of notifications sent in the last x days, etc.). Thus, the state of a page-admin pair may change over time.

In particular embodiments, each page-admin pair may also be associated with an action (denoted as a), which in particular embodiments may represent a decision to be made by the system with respect to the page-admin pair. For example, for each page-admin pair, the social-networking system may want to decide whether to not to send a notification to the administrator. In this case, the action may be an indicator of whether to send or not to send (e.g., send=1, not_send=0). The decision space, however, may be overly large in certain situations. For example, given X page-admin pairs in the system (e.g., 300 million in a social-networking system) and Y notifications available per day (e.g., 50 million), there exists (X choose Y) possible actions to choose from. A person of ordinary skill in the art would appreciate that having more than a few hundred actions makes most RL methods intractable. The process described below limits the action space for the system.

In particular embodiments, each page-admin pair may also be associated with a reward (denoted as r), which in particular embodiments may represent a stochastic function of utility based on the current state and action. For example, a reward may refer to a desired outcome. In the context of sending notifications to page administrators, a reward may be associated with a time period (e.g., day) and may be defined as the number of active administrators per day divided by the total number of administrators for that page. For example, if 2 of the 4 administrators were active on a given day, the reward associated with each of those administrators with respect to the page may be 0.50. In particular embodiments, the reward may be based on the total number of activities performed by the administrators of a page divided by the total number of administrators of that page (i.e., the average activities performed by each administrator). For example, if on a given day 10 activities were performed on a page that has 4 administrators, the reward associated with any of the administrators with respect to that page may be 2.5. In particular embodiments, the reward may instead be defined based on individual activities. For example, if one administrator performed 7 of the 10 activities, he/she may be associated with a reward of 7.

In particular embodiments, a transition (stochastic) function may be defined to maps state-action pairs to a future state. In particular embodiments, instead of a function, explicit transition information based on historical data of which admins became active or inactive on which days. For example, for a given page-admin pair, the social-networking system may track data relating to the administrator's state during particular time periods (e.g., day), whether notifications were sent to the administrator in those time periods, and whether the administrator managed his/her page during those time periods.

Given the above definitions, the goal of RL in particular embodiments may be to learn the value function/model V(s, a) for determining a discounted cumulative reward given a state/action pair. In other words, given a list of page/admin features (state) and whether notifications are sent to an administrator (action), V(s, a) should approximate the cumulative average administrator engagements (r) over the next N days.

In particular embodiments, V(s,a) for a particular page-admin pair may be represented as a sum of rewards, taking advantage of the fact that each reward R may represent a probability P:

$$\begin{matrix}V ( {s}_{0} , {a}_{0} ) = R ( {s}_{0} {,}_{a 0} ) + R ( {s}_{1} , {a}_{1} ) + … + R ( {s}_{N} , {a}_{N} ) \\ = P ( active \vert {s}_{0} {,}_{a 0} ) + P ( active \vert {s}_{1} {,}_{a 1} ) + … + P ( active \vert {s}_{N} {,}_{aN} )\end{matrix}$$

where s₀ represents the state on the day (or any other time-period unit) the action a₀ was taken, s₁ and a₁ represent the state and action taken on the next day, and so on. The state may change from day to day, since certain features may change (e.g., the number of engagements, whether there was activity within the last x days, etc.). In particular embodiments, a decay function y, which may be a value between 0 and 1, may be used to progressively diminish the significance of rewards that are further in the future. For example:

V(s₀,a₀)=R(s₀,a₀)+y R(s₁,a₁)+y²R(s₂,a₂)+ . . . +y^{N}R(s_{N},a_{N})

In particular embodiments, the value of y may be, e.g., 0.7, 0.8, 0.9, etc. Conceptually, this decay function may be used because an action on day 0 may correlate less with rewards further in the future, especially since the rewards in the future may be due to subsequent actions taken.

In particular embodiments, the model may be defined recurrently so that future predictions are based on earlier predictions. One advantage of the recurrent model is that the recurrent definition may be a better approximation of a future reward than any single example, so the recurrent model would provide a more accurate result. The recurrent model V(sₜ, a) may be defined as follows:

V(sₜ,aᵣ)=R(sₜ,aₜ)+y*V(sₜaₜ₊₁)

where sₜ represents a state on day t (or any other time-period unit), aₜ represents an action taken by the system on day t, R(sₜ, aₜ) represents the reward on day t, and y represents a decay function as described above. In this model, the rewards associated with time periods beyond t are recurrently defined using V(sₜ₊₁, aₜ₊₁). Conceptually, given a state s and an action a at time t, V(sₜ,aₜ) would predict, recurrently, the discounted (due to y) cumulative rewards over future time periods (e.g., 4, 5, 7, 10, etc., days). The cumulative reward may provide an improved representation of the effectiveness of a notification that is sent at time t, since it accounts for future user actions that may be influenced by the notification sent at time t and/or subsequent notifications (e.g., sent at time t+1, t+4, etc.).

In particular embodiments, it may be possible to revise the model such that the best possible future outcome is used (e.g., max (V(sₜ₊₁, aₜ₊₁)). However, this involves exploration and selection of the best possible action, which may be computationally impractical when the data set is large.

In particular embodiments, V(sₜ, aₜ) may be trained iteratively based on a set of training data. The training data may include any number of tuples (or data points). In particular embodiments, each tuple in the training data set may be associated with a page-admin pair and include the data (Sₜ, Aₜ, Rₜ, Sₜ₊₁, Aₜ₊₁), where Sₜ corresponds to a state of the associated page and administrator at time t, Aₜ corresponds to an action performed by the system at time t, Rₜ corresponds to a reward at time t, Sₜ₊₁ corresponds to a state of the associated page and administrator at time t+1, and Aₜ₊₁ corresponds to a subsequent action performed by the system at time t+1. Sₜ and Aₜ, may be used as input features sₜ and aₜ for V(sₜ, aₜ), respectively; and Rₜ, Sₜ₊₁, and Aₜ₊₁ may be used to create the recurrent label definition for the tuple based on, e.g., Rₜ+y*V(Sₜ₊₁, Aₜ₊₁). The training data set may include tuples associated with any number of page-admin pairs, and it may include multiple tuples associated with the same page-admin pair. For example, the time at which these data points are taken need not be uniform. For example, certain data points for the same page-admin pair may be correspond to data on days 0 and 1, and others may correspond to data on days 6 and 7. Each data point represents the state and action taken at time t, the resulting immediate reward at time t, and the subsequent state and action taken at time t+1 (e.g., the next day). As discussed above, the state of a page-admin pair and the action taken may differ from day to day.

In particular embodiments, the machine-learning model V(sₜ, aₜ) may be implemented using, e.g., a recurrent neural network, gradient boosted trees (GBT), or any other suitable machine-learning models. Once trained, the machine-learning model may take as input any given Sₜ and Aₜ of a page-admin pair and output a prediction of a (discounted) cumulative reward if action Aₜ (e.g., to send or not to send) is to be performed.

In particular embodiments, the trained V(s,a) model may be used to implement an optimization policy for sending out notifications based on the predicted effectiveness of a notification on an administrator:

π(s)=Σₙ₌₁^{N}maxᵤₙₛₑₙₜ(V(s,send)−V(s,no_send)).

Based on the long-term value (e.g., predicted reward over a 7 day period) of sending a notification and not sending a notification to each page-admin pair, notification may be selectively sent to those page-admin pairs that maximizes this difference (the difference represents an improvement or effectiveness of sending notifications). In particular embodiments, a notification may be sent to a particular administrator when the score difference is larger than a predetermined threshold, for example. After this, that pair may be removed from the candidate set, and the process may repeat N times until the target number of notifications has been sent (e.g., 50 million) or until the difference falls below some threshold.

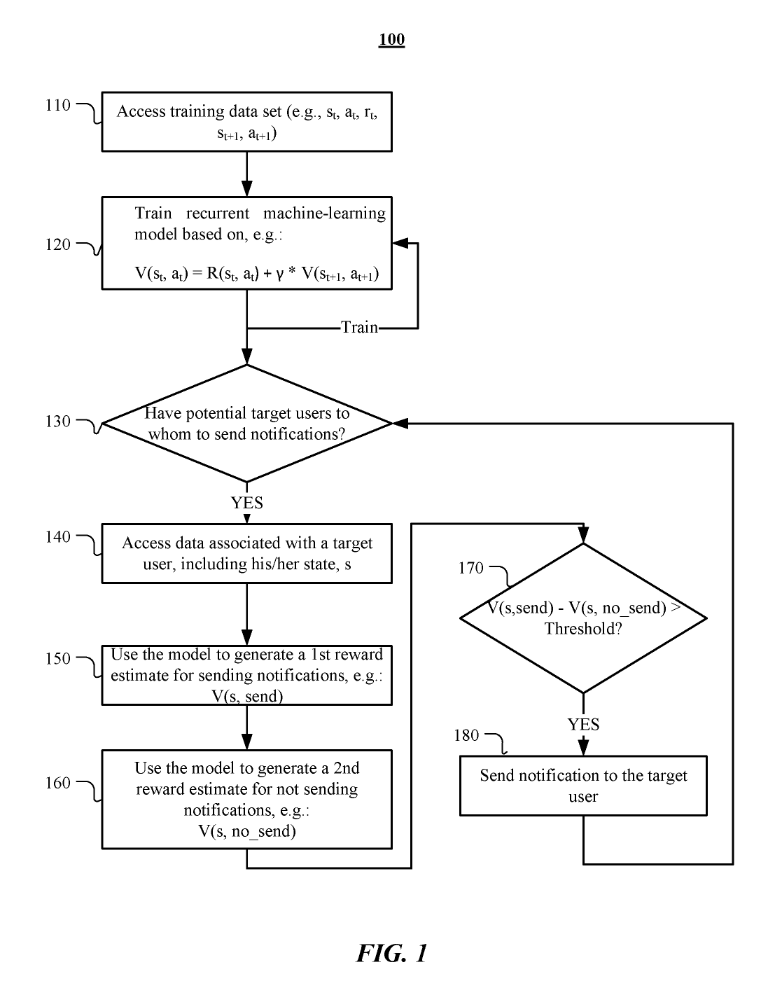

FIG. 1 illustrates an example method 100 for sending notifications based on predicted effectiveness of the notifications. The method may begin at step 110, where a notification system (e.g., of a social-networking system) accesses a data set comprising tuples (e.g., each tuple may comprise one or more associated values). Each tuple may be associated with a first user and comprising a first action (e.g., aₜ), a first state (e.g., sₜ), a first reward (e.g., rₜ), a second action (e.g., aₜ₊₁), and a second state (e.g., sₜ₊₁). A first time period (e.g., t) may be associated with the first state, the first action, and the first reward. A second time period (e.g., t+1) following the first time period may be associated with the second state and the second action. In particular embodiments, the first action may represent whether a first notification was sent to the first user in the first time period; the first state may represent characteristics associated with the first user in the first time period; and the first reward may represent a measure of activity performed by the first user in the first time period; the second action may represent whether a second notification was sent to the first user in the second time period; and the second state may represent characteristics associated with the first user in the second time period.

At step 120, the notification system may train a recurrent machine-learning model using the data set. The recurrent machine-learning model may be configured to take as inputs a state and an action associated with a user and a time period, and predict a cumulative reward over a plurality of time periods (e.g., 5, 7, 10 days). The cumulative reward may be recurrently defined based on at least (1) a reward R(sₜ, aₜ) associated with the user and the time period and (2) an application of the recurrent machine-learning model to a subsequent state and a subsequent action associated with the user and a subsequent time period relative to the time period (e.g., denoted V(sₜ₊₁, aₜ₊₁)). In particular embodiments, a decay function y may be applied to the application of the recurrent machine-learning model to the subsequent state and the subsequent action (e.g., denoted y V(sₜ₊₁, aₜ₊₁)). Training may take several iterations to converge and may be based on the optimization of a loss function.

In particular embodiments, once the recurrent machine-learning is trained, it may be used in operation to predict the effectiveness of a notification on a particular target user and use the prediction to decide whether to send that target user a notification. At step 130, the system may determine whether there are potential target users to notify. For example, the system may wish to send notifications to 50 million of 300 million page administrators. At step 140, the system may access data associated with a target user, such as data comprising the target user's state. At step 150, the system may generate a first reward estimate associated with the target user using the trained recurrent machine-learning model. The first reward estimate output by the model may represent a predicted cumulative reward of sending a notification to the target user. For example, the target user's state and an action representation of sending a notification (e.g., V(s, send)) to the target user may be used as inputs for the trained recurrent machine-learning model. In particular embodiments, at step 160, the system may generate a second reward estimate associated with the target user using the trained recurrent machine-learning model. The second reward estimate output by the model may represent a predicted cumulative reward of not sending a notification to the target user. For example, the target user's state and an action representation of not sending a notification (e.g., V(s, not_send)) to the target user may be used as inputs for the trained recurrent machine-learning model. In particular embodiments, the action representations may be represented numerically using, e.g., binary values (e.g., send=1 and not_send=0) or any other suitable numeric representation.

At step 170, the system may in particular embodiments determine whether to send a notification to the target user based on the first reward estimate. For example, the system may compare the first reward estimate to a predetermined threshold value. In particular embodiments, the system may determine whether to send a notification to the target user based on a difference between the first reward estimate and the second reward estimate, which may represent a predicted measure of the effectiveness of the notification on the target user. The difference may be compared to a predetermined threshold to determine whether sending notification is justified. At step 180, the system may send a notification to the target user if the threshold criteria are met. If the threshold criteria are not met, the system may choose to not send any notification to the target user. The steps 130 to 180 may repeat until the notification goal has been met (e.g., no more candidate target users or a target number of users have been notified).

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for sending notifications based on predicted effectiveness of the notifications, including the particular steps of the method of FIG. 1, this disclosure contemplates any suitable method for predicting effectiveness of notifications, including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

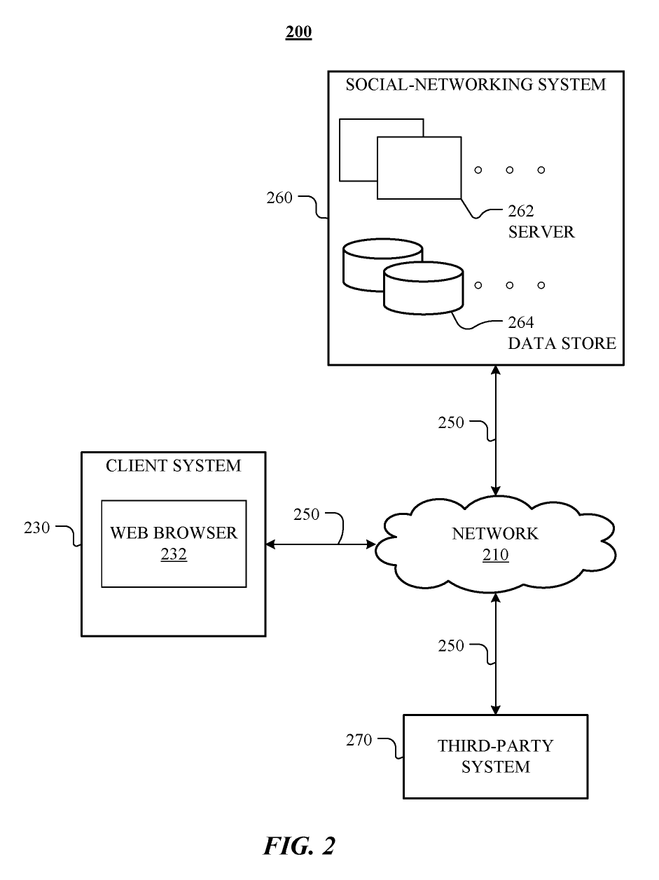

FIG. 2 illustrates an example network environment 200 associated with a social-networking system. Network environment 200 includes a client system 230, a social-networking system 260, and a third-party system 270 connected to each other by a network 210. Although FIG. 2 illustrates a particular arrangement of client system 230, social-networking system 260, third-party system 270, and network 210, this disclosure contemplates any suitable arrangement of client system 230, social-networking system 260, third-party system 270, and network 210. As an example and not by way of limitation, two or more of client system 230, social-networking system 260, and third-party system 270 may be connected to each other directly, bypassing network 210. As another example, two or more of client system 230, social-networking system 260, and third-party system 270 may be physically or logically co-located with each other in whole or in part. Moreover, although FIG. 2 illustrates a particular number of client systems 230, social-networking systems 260, third-party systems 270, and networks 210, this disclosure contemplates any suitable number of client systems 230, social-networking systems 260, third-party systems 270, and networks 210. As an example and not by way of limitation, network environment 200 may include multiple client system 230, social-networking systems 260, third-party systems 270, and networks 210.

This disclosure contemplates any suitable network 210. As an example and not by way of limitation, one or more portions of network 210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 210 may include one or more networks 210.

Links 250 may connect client system 230, social-networking system 260, and third-party system 270 to communication network 210 or to each other. This disclosure contemplates any suitable links 250. In particular embodiments, one or more links 250 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 250 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 250, or a combination of two or more such links 250. Links 250 need not necessarily be the same throughout network environment 200. One or more first links 250 may differ in one or more respects from one or more second links 250.

In particular embodiments, client system 230 may be an electronic device including hardware, software, or embedded logic components or a combination of two or more such components and capable of carrying out the appropriate functionalities implemented or supported by client system 230. As an example and not by way of limitation, a client system 230 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 230. A client system 230 may enable a network user at client system 230 to access network 210. A client system 230 may enable its user to communicate with other users at other client systems 230.

In particular embodiments, client system 230 may include a web browser 232, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 230 may enter a Uniform Resource Locator (URL) or other address directing the web browser 232 to a particular server (such as server 262, or a server associated with a third-party system 270), and the web browser 232 may generate a Hyper Text Transfer Protocol (HTTP) request and communicate the HTTP request to server. The server may accept the HTTP request and communicate to client system 230 one or more Hyper Text Markup Language (HTML) files responsive to the HTTP request. Client system 230 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 260 may be a network-addressable computing system that can host an online social network. Social-networking system 260 may generate, store, receive, and send social-networking data, such as, for example, user-profile data, concept-profile data, social-graph information, or other suitable data related to the online social network. Social-networking system 260 may be accessed by the other components of network environment 200 either directly or via network 210. As an example and not by way of limitation, client system 230 may access social-networking system 260 using a web browser 232, or a native application associated with social-networking system 260 (e.g., a mobile social-networking application, a messaging application, another suitable application, or any combination thereof) either directly or via network 210. In particular embodiments, social-networking system 260 may include one or more servers 262. Each server 262 may be a unitary server or a distributed server spanning multiple computers or multiple datacenters. Servers 262 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 262 may include hardware, software, or embedded logic components or a combination of two or more such components for carrying out the appropriate functionalities implemented or supported by server 262. In particular embodiments, social-networking system 260 may include one or more data stores 264. Data stores 264 may be used to store various types of information. In particular embodiments, the information stored in data stores 264 may be organized according to specific data structures. In particular embodiments, each data store 264 may be a relational, columnar, correlation, or other suitable database. Although this disclosure describes or illustrates particular types of databases, this disclosure contemplates any suitable types of databases. Particular embodiments may provide interfaces that enable a client system 230, a social-networking system 260, or a third-party system 270 to manage, retrieve, modify, add, or delete, the information stored in data store 264.

In particular embodiments, social-networking system 260 may store one or more social graphs in one or more data stores 264. In particular embodiments, a social graph may include multiple nodes—which may include multiple user nodes (each corresponding to a particular user) or multiple concept nodes (each corresponding to a particular concept)—and multiple edges connecting the nodes. Social-networking system 260 may provide users of the online social network the ability to communicate and interact with other users. In particular embodiments, users may join the online social network via social-networking system 260 and then add connections (e.g., relationships) to a number of other users of social-networking system 260 to whom they want to be connected. Herein, the term “friend” may refer to any other user of social-networking system 260 with whom a user has formed a connection, association, or relationship via social-networking system 260.

In particular embodiments, social-networking system 260 may provide users with the ability to take actions on various types of items or objects, supported by social-networking system 260. As an example and not by way of limitation, the items and objects may include groups or social networks to which users of social-networking system 260 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 260 or by an external system of third-party system 270, which is separate from social-networking system 260 and coupled to social-networking system 260 via a network 210.

In particular embodiments, social-networking system 260 may be capable of linking a variety of entities. As an example and not by way of limitation, social-networking system 260 may enable users to interact with each other as well as receive content from third-party systems 270 or other entities, or to allow users to interact with these entities through an application programming interfaces (API) or other communication channels.

In particular embodiments, a third-party system 270 may include one or more types of servers, one or more data stores, one or more interfaces, including but not limited to APIs, one or more web services, one or more content sources, one or more networks, or any other suitable components, e.g., that servers may communicate with. A third-party system 270 may be operated by a different entity from an entity operating social-networking system 260. In particular embodiments, however, social-networking system 260 and third-party systems 270 may operate in conjunction with each other to provide social-networking services to users of social-networking system 260 or third-party systems 270. In this sense, social-networking system 260 may provide a platform, or backbone, which other systems, such as third-party systems 270, may use to provide social-networking services and functionality to users across the Internet.

In particular embodiments, a third-party system 270 may include a third-party content object provider. A third-party content object provider may include one or more sources of content objects, which may be communicated to a client system 230. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 260 also includes user-generated content objects, which may enhance a user's interactions with social-networking system 260. User-generated content may include anything a user can add, upload, send, or “post” to social-networking system 260. As an example and not by way of limitation, a user communicates posts to social-networking system 260 from a client system 230. Posts may include data such as status updates or other textual data, location information, photos, videos, links, music or other similar data or media. Content may also be added to social-networking system 260 by a third-party through a “communication channel,” such as a newsfeed or stream.

In particular embodiments, social-networking system 260 may include a variety of servers, sub-systems, programs, modules, logs, and data stores. In particular embodiments, social-networking system 260 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 260 may also include suitable components such as network interfaces, security mechanisms, load balancers, failover servers, management-and-network-operations consoles, other suitable components, or any suitable combination thereof. In particular embodiments, social-networking system 260 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 260 to one or more client systems 230 or one or more third-party system 270 via network 210. The web server may include a mail server or other messaging functionality for receiving and routing messages between social-networking system 260 and one or more client systems 230. An API-request server may allow a third-party system 270 to access information from social-networking system 260 by calling one or more APIs. An action logger may be used to receive communications from a web server about a user's actions on or off social-networking system 260. In conjunction with the action log, a third-party-content-object log may be maintained of user exposures to third-party-content objects. A notification controller may provide information regarding content objects to a client system 230. Information may be pushed to a client system 230 as notifications, or information may be pulled from client system 230 responsive to a request received from client system 230. Authorization servers may be used to enforce one or more privacy settings of the users of social-networking system 260. A privacy setting of a user determines how particular information associated with a user can be shared. The authorization server may allow users to opt in to or opt out of having their actions logged by social-networking system 260 or shared with other systems (e.g., third-party system 270), such as, for example, by setting appropriate privacy settings. Third-party-content-object stores may be used to store content objects received from third parties, such as a third-party system 270. Location stores may be used for storing location information received from client systems 230 associated with users. Advertisement-pricing modules may combine social information, the current time, location information, or other suitable information to provide relevant advertisements, in the form of notifications, to a user.

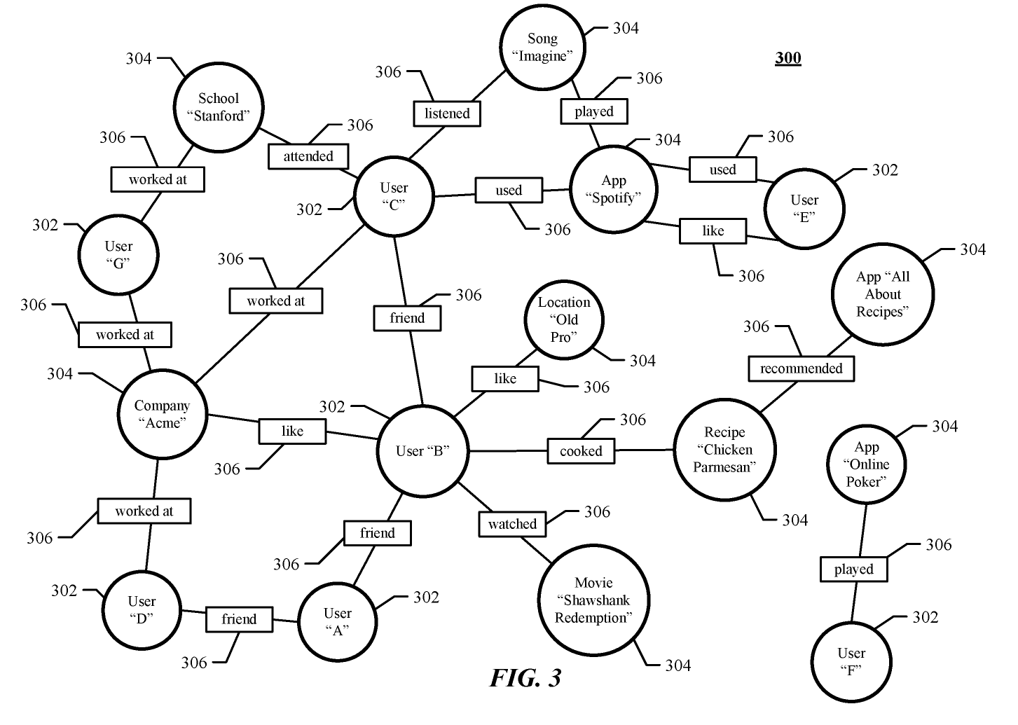

FIG. 3 illustrates example social graph 300. In particular embodiments, social-networking system 260 may store one or more social graphs 300 in one or more data stores. In particular embodiments, social graph 300 may include multiple nodes—which may include multiple user nodes 302 or multiple concept nodes 304—and multiple edges 306 connecting the nodes. Example social graph 300 illustrated in FIG. 3 is shown, for didactic purposes, in a two-dimensional visual map representation. In particular embodiments, a social-networking system 260, client system 230, or third-party system 270 may access social graph 300 and related social-graph information for suitable applications. The nodes and edges of social graph 300 may be stored as data objects, for example, in a data store (such as a social-graph database). Such a data store may include one or more searchable or queryable indexes of nodes or edges of social graph 300.

In particular embodiments, a user node 302 may correspond to a user of social-networking system 260. As an example and not by way of limitation, a user may be an individual (human user), an entity (e.g., an enterprise, business, or third-party application), or a group (e.g., of individuals or entities) that interacts or communicates with or over social-networking system 260. In particular embodiments, when a user registers for an account with social-networking system 260, social-networking system 260 may create a user node 302 corresponding to the user, and store the user node 302 in one or more data stores. Users and user nodes 302 described herein may, where appropriate, refer to registered users and user nodes 302 associated with registered users. In addition or as an alternative, users and user nodes 302 described herein may, where appropriate, refer to users that have not registered with social-networking system 260. In particular embodiments, a user node 302 may be associated with information provided by a user or information gathered by various systems, including social-networking system 260. As an example and not by way of limitation, a user may provide his or her name, profile picture, contact information, birth date, sex, marital status, family status, employment, education background, preferences, interests, or other demographic information. In particular embodiments, a user node 302 may be associated with one or more data objects corresponding to information associated with a user. In particular embodiments, a user node 302 may correspond to one or more webpages.

In particular embodiments, a concept node 304 may correspond to a concept. As an example and not by way of limitation, a concept may correspond to a place (such as, for example, a movie theater, restaurant, landmark, or city); a website (such as, for example, a website associated with social-network system 260 or a third-party website associated with a web-application server); an entity (such as, for example, a person, business, group, sports team, or celebrity); a resource (such as, for example, an audio file, video file, digital photo, text file, structured document, or application) which may be located within social-networking system 260 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 304 may be associated with information of a concept provided by a user or information gathered by various systems, including social-networking system 260. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 304 may be associated with one or more data objects corresponding to information associated with concept node 304. In particular embodiments, a concept node 304 may correspond to one or more webpages.

In particular embodiments, a node in social graph 300 may represent or be represented by a webpage (which may be referred to as a “profile page”). Profile pages may be hosted by or accessible to social-networking system 260. Profile pages may also be hosted on third-party websites associated with a third-party system 270. As an example and not by way of limitation, a profile page corresponding to a particular external webpage may be the particular external webpage and the profile page may correspond to a particular concept node 304. Profile pages may be viewable by all or a selected subset of other users. As an example and not by way of limitation, a user node 302 may have a corresponding user-profile page in which the corresponding user may add content, make declarations, or otherwise express himself or herself. As another example and not by way of limitation, a concept node 304 may have a corresponding concept-profile page in which one or more users may add content, make declarations, or express themselves, particularly in relation to the concept corresponding to concept node 304.

In particular embodiments, a concept node 304 may represent a third-party webpage or resource hosted by a third-party system 270. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 230 to send to social-networking system 260 a message indicating the user's action. In response to the message, social-networking system 260 may create an edge (e.g., a check-in-type edge) between a user node 302 corresponding to the user and a concept node 304 corresponding to the third-party webpage or resource and store edge 306 in one or more data stores.

In particular embodiments, a pair of nodes in social graph 300 may be connected to each other by one or more edges 306. An edge 306 connecting a pair of nodes may represent a relationship between the pair of nodes. In particular embodiments, an edge 306 may include or represent one or more data objects or attributes corresponding to the relationship between a pair of nodes. As an example and not by way of limitation, a first user may indicate that a second user is a “friend” of the first user. In response to this indication, social-networking system 260 may send a “friend request” to the second user. If the second user confirms the “friend request,” social-networking system 260 may create an edge 306 connecting the first user's user node 302 to the second user's user node 302 in social graph 300 and store edge 306 as social-graph information in one or more of data stores 264. In the example of FIG. 3, social graph 300 includes an edge 306 indicating a friend relation between user nodes 302 of user “A” and user “B” and an edge indicating a friend relation between user nodes 302 of user “C” and user “B.” Although this disclosure describes or illustrates particular edges 306 with particular attributes connecting particular user nodes 302, this disclosure contemplates any suitable edges 306 with any suitable attributes connecting user nodes 302. As an example and not by way of limitation, an edge 306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 300 by one or more edges 306.

In particular embodiments, an edge 306 between a user node 302 and a concept node 304 may represent a particular action or activity performed by a user associated with user node 302 toward a concept associated with a concept node 304. As an example and not by way of limitation, as illustrated in FIG. 3, a user may “like,” “attended,” “played,” “listened,” “cooked,” “worked at,” or “watched” a concept, each of which may correspond to an edge type or subtype. A concept-profile page corresponding to a concept node 304 may include, for example, a selectable “check in” icon (such as, for example, a clickable “check in” icon) or a selectable “add to favorites” icon. Similarly, after a user clicks these icons, social-networking system 260 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 260 may create a “listened” edge 306 and a “used” edge (as illustrated in FIG. 3) between user nodes 302 corresponding to the user and concept nodes 304 corresponding to the song and application to indicate that the user listened to the song and used the application. Moreover, social-networking system 260 may create a “played” edge 306 (as illustrated in FIG. 3) between concept nodes 304 corresponding to the song and the application to indicate that the particular song was played by the particular application. In this case, “played” edge 306 corresponds to an action performed by an external application (SPOTIFY) on an external audio file (the song “Imagine”). Although this disclosure describes particular edges 306 with particular attributes connecting user nodes 302 and concept nodes 304, this disclosure contemplates any suitable edges 306 with any suitable attributes connecting user nodes 302 and concept nodes 304. Moreover, although this disclosure describes edges between a user node 302 and a concept node 304 representing a single relationship, this disclosure contemplates edges between a user node 302 and a concept node 304 representing one or more relationships. As an example and not by way of limitation, an edge 306 may represent both that a user likes and has used at a particular concept. Alternatively, another edge 306 may represent each type of relationship (or multiples of a single relationship) between a user node 302 and a concept node 304 (as illustrated in FIG. 3 between user node 302 for user “E” and concept node 304 for “SPOTIFY”).

In particular embodiments, social-networking system 260 may create an edge 306 between a user node 302 and a concept node 304 in social graph 300. As an example and not by way of limitation, a user viewing a concept-profile page (such as, for example, by using a web browser or a special-purpose application hosted by the user's client system 230) may indicate that he or she likes the concept represented by the concept node 304 by clicking or selecting a “Like” icon, which may cause the user's client system 230 to send to social-networking system 260 a message indicating the user's liking of the concept associated with the concept-profile page. In response to the message, social-networking system 260 may create an edge 306 between user node 302 associated with the user and concept node 304, as illustrated by “like” edge 306 between the user and concept node 304. In particular embodiments, social-networking system 260 may store an edge 306 in one or more data stores. In particular embodiments, an edge 306 may be automatically formed by social-networking system 260 in response to a particular user action. As an example and not by way of limitation, if a first user uploads a picture, watches a movie, or listens to a song, an edge 306 may be formed between user node 302 corresponding to the first user and concept nodes 304 corresponding to those concepts. Although this disclosure describes forming particular edges 306 in particular manners, this disclosure contemplates forming any suitable edges 306 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 260). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 260 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 260) or RSVP (e.g., through social-networking system 260) to an event associated with the advertisement. In addition or as an alternative, an advertisement may include social-networking-system content directed to the user. As an example and not by way of limitation, an advertisement may display information about a friend of the user within social-networking system 260 who has taken an action associated with the subject matter of the advertisement.

In particular embodiments, social-networking system 260 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 270 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 260 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 260 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 260 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 260 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 260 may calculate a coefficient based on a user's actions. Social-networking system 260 may monitor such actions on the online social network, on a third-party system 270, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 260 may calculate a coefficient based on the user's actions with particular types of content. The content may be associated with the online social network, a third-party system 270, or another suitable system. The content may include users, profile pages, posts, news stories, headlines, instant messages, chat room conversations, emails, advertisements, pictures, video, music, other suitable objects, or any combination thereof. Social-networking system 260 may analyze a user's actions to determine whether one or more of the actions indicate an affinity for subject matter, content, other users, and so forth. As an example and not by way of limitation, if a user frequently posts content related to “coffee” or variants thereof, social-networking system 260 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 260 may calculate a coefficient based on the type of relationship between particular objects. Referencing the social graph 300, social-networking system 260 may analyze the number and/or type of edges 306 connecting particular user nodes 302 and concept nodes 304 when calculating a coefficient. As an example and not by way of limitation, user nodes 302 that are connected by a spouse-type edge (representing that the two users are married) may be assigned a higher coefficient than a user nodes 302 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 260 may determine that the user has a higher coefficient with respect to the first photo than the second photo because having a tagged-in-type relationship with content may be assigned a higher weight and/or rating than having a like-type relationship with content. In particular embodiments, social-networking system 260 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 260 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 300. As an example and not by way of limitation, social-graph entities that are closer in the social graph 300 (i.e., fewer degrees of separation) may have a higher coefficient than entities that are further apart in the social graph 300.

In particular embodiments, social-networking system 260 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 230 of the user). A first user may be more interested in other users or concepts that are closer to the first user. As an example and not by way of limitation, if a user is one mile from an airport and two miles from a gas station, social-networking system 260 may determine that the user has a higher coefficient for the airport than the gas station based on the proximity of the airport to the user.

In particular embodiments, social-networking system 260 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 260 may provide information that is relevant to user's interests and current circumstances, increasing the likelihood that they will find such information of interest. In particular embodiments, social-networking system 260 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 260 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 260 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 270 (e.g., via an API or other communication channel), or from another suitable system. In response to the request, social-networking system 260 may calculate the coefficient (or access the coefficient information if it has previously been calculated and stored). In particular embodiments, social-networking system 260 may measure an affinity with respect to a particular process. Different processes (both internal and external to the online social network) may request a coefficient for a particular object or set of objects. Social-networking system 260 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

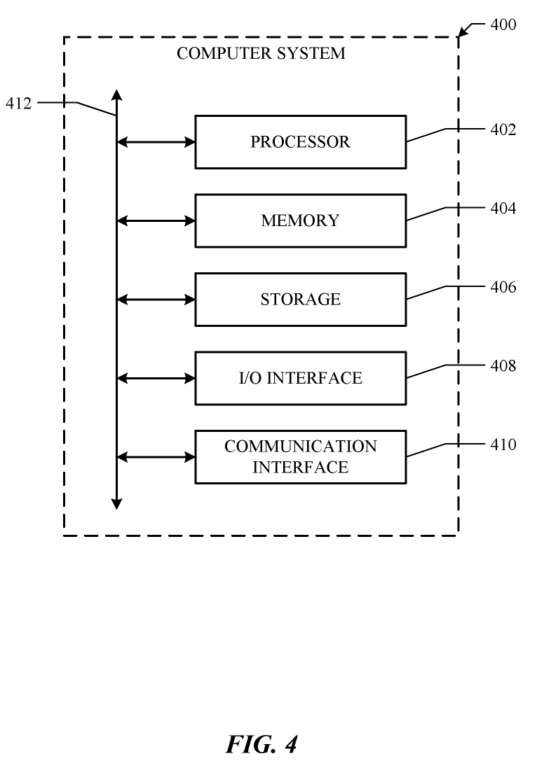

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
by a computing system, accessing a data set comprising tuples, each tuple being associated with a first user and comprising a first action, a first state, a first reward, a second action, and a second state, wherein a first time period is associated with the first state, the first action, and the first reward, wherein a second time period following the first time period is associated with the second state and the second action, wherein the first action represents whether a first notification was sent to the first user in the first time period, wherein the first state represents characteristics associated with the first user in the first time period, wherein the first reward represents a measure of activity performed by the first user in the first time period, wherein the second action represents whether a second notification was sent to the first user in the second time period, and wherein the second state represents characteristics associated with the first user in the second time period;
by the computing system, training a recurrent machine-learning model using the data set, wherein the recurrent machine-learning model is configured to take as inputs a state and an action and predict a cumulative reward over a plurality of time periods, wherein the state and the action are associated with a user and a time period, wherein the cumulative reward is recurrently defined based on at least (1) a reward associated with the user and the time period and (2) an application of the recurrent machine-learning model to a subsequent state and a subsequent action associated with the user and a subsequent time period relative to the time period;
by the computing system, accessing data associated with a target user, the data comprising the target user's state;
by the computing system, generating a first reward estimate associated with the target user using the trained recurrent machine-learning model, wherein the target user's state and an action representation of sending a notification to the target user are used as inputs for the trained recurrent machine-learning model; and
by the computing device, sending a notification to the target user based on the first reward estimate.

2. The method of claim 1, wherein the definition of the cumulative reward further comprises a decay function applied to the application of the recurrent machine-learning model to the subsequent state and the subsequent action.

3. The method of claim 1, further comprising:
by the computing system, generating a second reward estimate associated with the target user using the trained recurrent machine-learning model, wherein the target user's state and an action representation of not sending a notification to the target user are used as inputs for the trained recurrent machine-learning model;
wherein the sending of the notification to the target user is further based on the second reward estimate.

4. The method of claim 3, wherein the sending of the notification to the target user is further based on a difference between the first reward estimate and the second reward estimate.

5. The method of claim 1, wherein during the training:
the first action and the first state of each of the tuples in the data set are used as inputs to the recurrent machine-learning model, and
the first reward, the second state, and the second action of each of the tuples in the data set are used to define a label for the tuple.

6. The method of claim 1, wherein each of the tuples in the data set is associated with an administrator and online content managed by the administrator.

7. The method of claim 1,
wherein the first user is an administrator of a page on a social-networking system;
wherein the first state further represents characteristics associated with the page in the first time period; and
wherein the second state further represents characteristics associated with the page in the second time period.

8. The method of claim 7, wherein the characteristics associated with the page in the first time period comprise a duration since the last time prior to the first time period the first user managed the page.

9. The method of claim 7, wherein the measure of activity performed by the first user in the first time period is associated with whether the first user managed the page after the first notification was sent.

10. The method of claim 7, wherein the measure of activity performed by the first user in the first time period is associated with an average number of times the page is managed in the first time period by each administrator of the page.

11. The method of claim 1, wherein the second state is different from the first state.

12. The method of claim 1, wherein the second action is different from the first action.

13. One or more computer-readable non-transitory storage media embodying software that is operable when executed to:
access a data set comprising tuples, each tuple being associated with a first user and comprising a first action, a first state, a first reward, a second action, and a second state, wherein a first time period is associated with the first state, the first action, and the first reward, wherein a second time period following the first time period is associated with the second state and the second action, wherein the first action represents whether a first notification was sent to the first user in the first time period, wherein the first state represents characteristics associated with the first user in the first time period, wherein the first reward represents a measure of activity performed by the first user in the first time period, wherein the second action represents whether a second notification was sent to the first user in the second time period, and wherein the second state represents characteristics associated with the first user in the second time period;
train a recurrent machine-learning model using the data set, wherein the recurrent machine-learning model is configured to take as inputs a state and an action and predict a cumulative reward over a plurality of time periods, wherein the state and the action are associated with a user and a time period, wherein the cumulative reward is recurrently defined based on at least (1) a reward associated with the user and the time period and (2) an application of the recurrent machine-learning model to a subsequent state and a subsequent action associated with the user and a subsequent time period relative to the time period;
access data associated with a target user, the data comprising the target user's state;
generate a first reward estimate associated with the target user using the trained recurrent machine-learning model, wherein the target user's state and an action representation of sending a notification to the target user are used as inputs for the trained recurrent machine-learning model; and
send a notification to the target user based on the first reward estimate.

14. The media of claim 13, wherein the definition of the cumulative reward further comprises a decay function applied to the application of the recurrent machine-learning model to the subsequent state and the subsequent action.

15. The media of claim 13, wherein the software is further operable when executed to:
generate a second reward estimate associated with the target user using the trained recurrent machine-learning model, wherein the target user's state and an action representation of not sending a notification to the target user are used as inputs for the trained recurrent machine-learning model;
wherein the sending of the notification to the target user is further based on the second reward estimate.

16. The media of claim 15, wherein the sending of the notification to the target user is further based on a difference between the first reward estimate and the second reward estimate.

17. One or more computer-readable non-transitory storage media embodying software that is operable when executed to:
access a data set comprising tuples, each tuple being associated with a first user and comprising a first action, a first state, a first reward, a second action, and a second state, wherein a first time period is associated with the first state, the first action, and the first reward, wherein a second time period following the first time period is associated with the second state and the second action, wherein the first action represents whether a first notification was sent to the first user in the first time period, wherein the first state represents characteristics associated with the first user in the first time period, wherein the first reward represents a measure of activity performed by the first user in the first time period, wherein the second action represents whether a second notification was sent to the first user in the second time period, and wherein the second state represents characteristics associated with the first user in the second time period;
train a recurrent machine-learning model using the data set, wherein the recurrent machine-learning model is configured to take as inputs a state and an action and predict a cumulative reward over a plurality of time periods, wherein the state and the action are associated with a user and a time period, wherein the cumulative reward is recurrently defined based on at least (1) a reward associated with the user and the time period and (2) an application of the recurrent machine-learning model to a subsequent state and a subsequent action associated with the user and a subsequent time period relative to the time period;
access data associated with a target user, the data comprising the target user's state;
generate a first reward estimate associated with the target user using the trained recurrent machine-learning model, wherein the target user's state and an action representation of sending a notification to the target user are used as inputs for the trained recurrent machine-learning model; and
send a notification to the target user based on the first reward estimate.

18. The system of claim 17, wherein the definition of the cumulative reward further comprises a decay function applied to the application of the recurrent machine-learning model to the subsequent state and the subsequent action.

19. The system of claim 17, wherein the processors are further operable when executing the instructions to:
generate a second reward estimate associated with the target user using the trained recurrent machine-learning model, wherein the target user's state and an action representation of not sending a notification to the target user are used as inputs for the trained recurrent machine-learning model;
wherein the sending of the notification to the target user is further based on the second reward estimate.

20. The system of claim 19, wherein the sending of the notification to the target user is further based on a difference between the first reward estimate and the second reward estimate.
